(19) United States
(12) Patent Application Publication
(10) Pub. No.: US 2007/0273753 A1
(43) Pub. Date: Nov. 29, 2007

(54) Video access system and recording method

(75) Inventor: Chang-Hung Lee, Dounan Township (TW)

Correspondence Address: RABIN & Berdo, PC, 1101 14TH STREET, NW, SUITE 500, WASHINGTON, DC, 20005, US

(73) Assignee: BenQ Corporation, Taoyuan Shien (TW)

(21) Appl. No.: 11/797,737

(22) Filed: May 7, 2007

(30) Foreign Application Priority Data
May 10, 2006 (TW) 095116607

(51) Int. Cl. H04N 7/14

(52) U.S. Cl. 348/14.02

(57) ABSTRACT

A video accessing system and recording method are provided. The video accessing system comprises a video access apparatus and a mobile communication apparatus. The video access apparatus is for receiving a piece of real-time information comprises a buffer, an information extracting unit, a communication module and a recording module. The buffer is for registering the real-time information. The information extracting unit is for generating a first message according to the real-time information. The communication module is for outputting the first message. The recording module is for recording the real-time information to a storage media. The mobile communication apparatus comprises a playing unit and a communication module. The communication module, used for receiving and outputting the first message to the playing unit, further sends a second message to the video access apparatus according to the first message for driving the recording module to implement the action requested by the second message.

This application claims the benefit of Taiwan application Serial No. 95116607, filed MAY 10, 2006, the subject matter of which is incorporated herein by reference.

### BACKGROUND OF THE INVENTION

1. Field of the Invention

The invention relates in general to a video accessing system and recording method, and more particularly to a video accessing system with real-time broadcasting function and a recording method.

2. Description of the Related Art

When a user would like to set timer recording to a TV program by a conventional video recorder, the user needs to inquire the TV program and broadcasting schedule of every channel first, select his or her favorite TV programs next, and then set timer recording to the conventional video recorder with respect to the TV programs, broadcasting schedule and broadcasting channels. After that, when the selected TV program is broadcasted, the conventional video recorder will record the selected TV program according to previous setting.

However, the inquiry of TV programs and broadcasting schedule is tedious, and worse than that, if the broadcasting schedule of a selected TV program suddenly changes, the user will not be able to record this TV program.

Moreover, if the user does not have the knowledge of the broadcasting schedule of his or her favorite TV programs, the user will not be able to set timer recording to the conventional video recorder, hence missing the favorite program.

### SUMMARY OF THE INVENTION

The invention is directed to a video accessing system with real-time broadcasting function and a recording method. As the mobile communication apparatus broadcasts real-time information instantaneously, the user can obtain the contents of TV program promptly so as to select his or her favorite programs for timer-recording, hence making program recording more conveniently.

According to a first aspect of the present invention, a recording method is provided. The recording method comprises the following steps.

Firstly, a piece of real-time information is inputted to a video access apparatus.

Next, a first message is generated according to the real-time information and then outputted to the mobile communication apparatus.

Lastly, a second message is sent to the video access apparatus according to the first message for driving the video access apparatus to implement the action requested by the second message.

According to a second aspect of the present invention, a video accessing system is provided. The video accessing system comprises a video access apparatus and a mobile communication apparatus. The video access apparatus receives a piece of real-time information, and comprises a buffer, an information extracting unit, a communication module and a recording module. The buffer is used for registering the real-time information. The information extracting unit is used for generating a first message according to the real-time information. The communication module is used for outputting the first message. The recording module is used for recording the real-time information of the buffer to a storage media. The mobile communication apparatus comprises a playing unit and a communication module. The communication module, used for receiving and outputting the first message to the playing unit, further sends a second message to the video access apparatus according to the first message for driving the recording module to implement the action requested by the second message.

The invention will become apparent from the following detailed description of the preferred but non-limiting embodiments. The following description is made with reference to the accompanying drawings.

### BRIEF DESCRIPTION OF THE DRAWINGS

FIG. 1 is a block diagram of a video accessing system according to the invention;

FIG. 2 is a block diagram of a video accessing system according to a first embodiment of the invention;

FIG. 3 is a block diagram of a video accessing system according to a second embodiment of the invention;

FIG. 4 is a perspective of the second embodiment;

FIG. 5 is a block diagram of a video accessing system according to a third embodiment of the invention; and

FIG. 6 is a flowchart of a recording method according to a preferred embodiment of the invention.

### DETAILED DESCRIPTION OF THE INVENTION

A more convenient recording method is provided in the invention. According to a video accessing system of the embodiments of the invention, TV programs are instantaneously sent to a mobile communication apparatus by a first message for the user to select and record his or her favorite TV programs. Thus, the user controls the video access apparatus to record his or her favorite TV programs via the mobile communication apparatus.

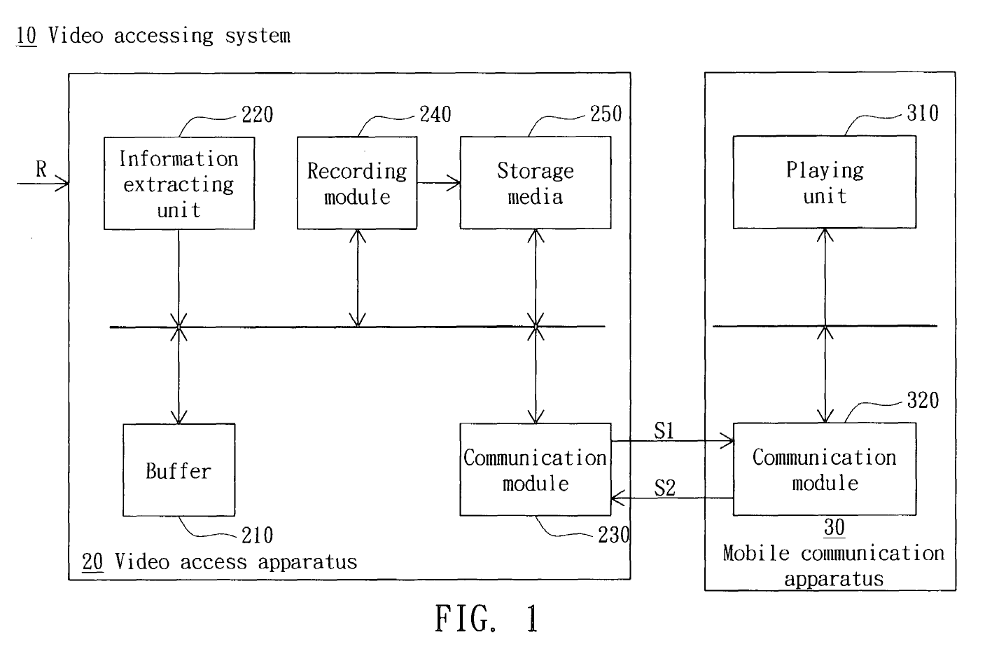

Referring to FIG. 1, a block diagram of a video accessing system according to the invention is shown. The video accessing system 10 comprises a video access apparatus 20 and a mobile communication apparatus 30. Examples of the video access apparatus 20 include a digital video recorder (DVR), and examples of the mobile communication apparatus 30 include a mobile phone or personal digital assistant (PDA).

The video access apparatus 20 receives real-time information R. Examples of the real-time information R include various TV programs such as sport, movie, news, drama episodes, and so on. The video access apparatus 20 generates a first message S1 according to the real-time information R and outputs the first message S1 to the mobile communication apparatus 30. Examples of the first message S1 include a text message, an audio frequency signal or an image signal.

According to the first message S1, the user sends a second message S2 to the video access apparatus 20 via the mobile communication apparatus 30. Then the video access apparatus 20 implements the action requested by the second message S2 accordingly.

Furthermore, the video access apparatus 20 comprises a buffer 210, an information extracting unit 220, a communication module 230 and a recording module 240. The buffer 210 is used for registering the real-time information R. The information extracting unit 220 generates a first message S1 according to the real-time information R, wherein the first message S1 is outputted to the mobile communication apparatus 30 via the communication module 230.

The mobile communication apparatus 30 comprises a communication module 310 and a playing unit 320. Examples of the playing unit 320 include a speaker and a display. The communication module 320 is used for receiving and outputting the first message S1 to the playing unit 310. The user plays the first message S1 by the playing unit 310, and sends a second message S2 to the video access apparatus 20 via the communication module 310 for driving the recording module 240 to implement the action requested by the second message S2. Examples of the action requested by the second message S2 include recording the real-time information R of the buffer 210 to a storage media 250 such as a hard disk driver or an optical disc for example.

### FIRST EMBODIMENT

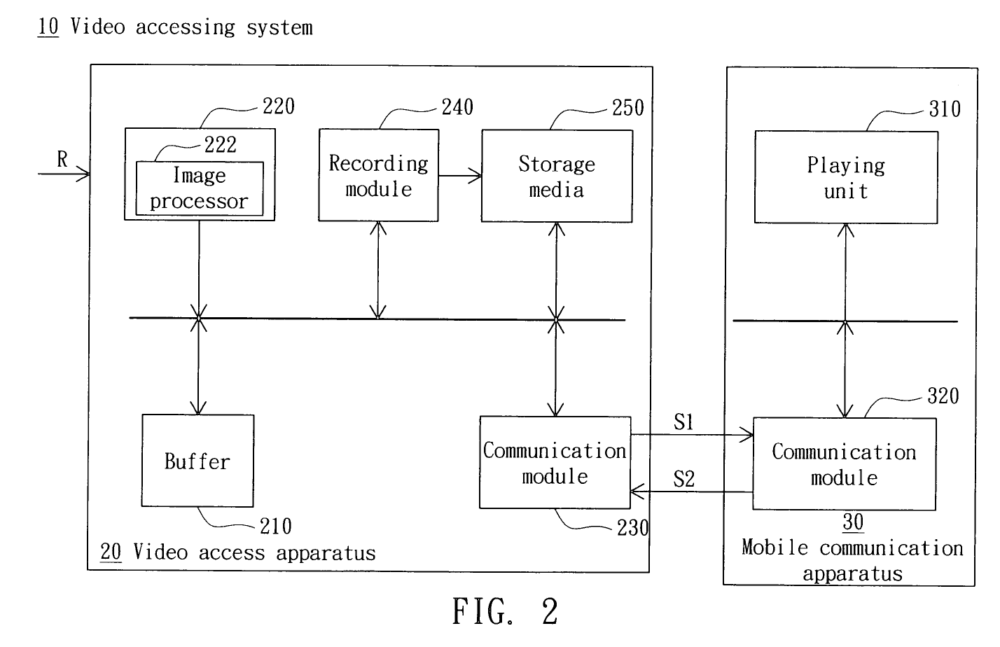

Referring to FIG. 2, a block diagram of a video accessing system according to a first embodiment of the invention is shown. In the first embodiment, the playing unit 310 of the mobile communication apparatus 30 is exemplified by a display. The information extracting unit 220 of the video access apparatus 20 further comprises an image processor 222, which generates a first message S1 according to the real-time information R. The first message S1 is an image signal.

After the first message S1 was received by the communication module 320 of the mobile communication apparatus 30, the first message S1 is outputted to the playing unit 310 and displayed on the image frame. According to the image frame displayed on the playing unit 310, the user sends a second message S2 to the video access apparatus 20 via the communication module 320 for driving the recording module 240 to implement the action requested by the second message S2.

### SECOND EMBODIMENT

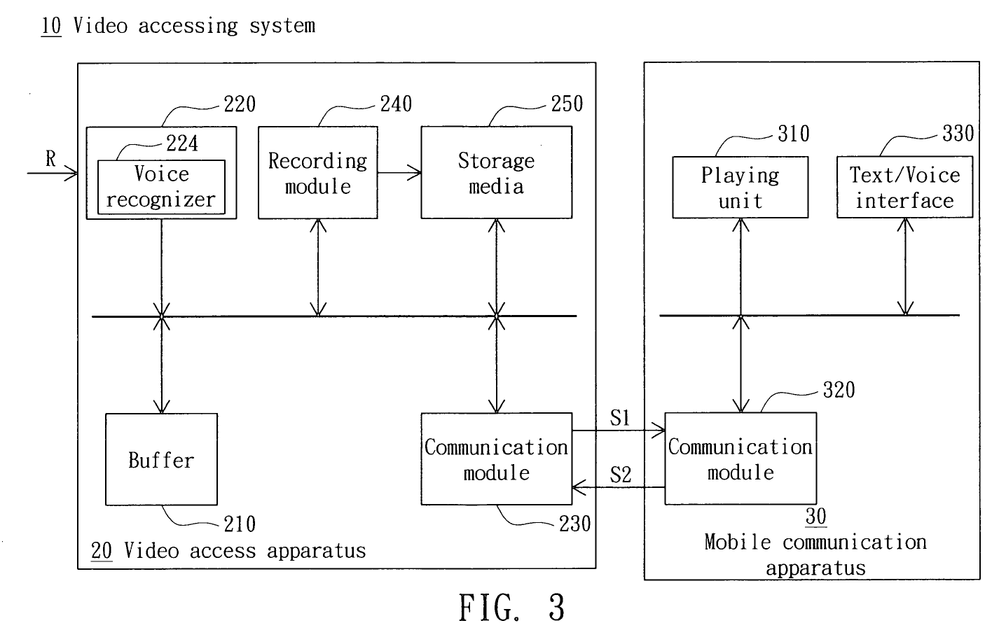

Referring to FIG. 3, a block diagram of a video accessing system according to a second embodiment of the invention is shown. The playing unit 310 of the mobile communication apparatus 30 is exemplified by a display. The information extracting unit 220 of the video access apparatus 20 further comprises a voice recognizer 224 which generates a first message S1 according to the real-time information R. The first message S1 is a text message.

After the first message S1 is received by the communication module 320 of the mobile communication apparatus 30, the first message S1 is outputted to the playing unit 310 and a text message is displayed thereon. According to the text message displayed on the playing unit 310, the user sends a second message S2 to the video access apparatus 20 via the communication module 320 for driving the recording module 240 to implement the action requested by the second message S2.

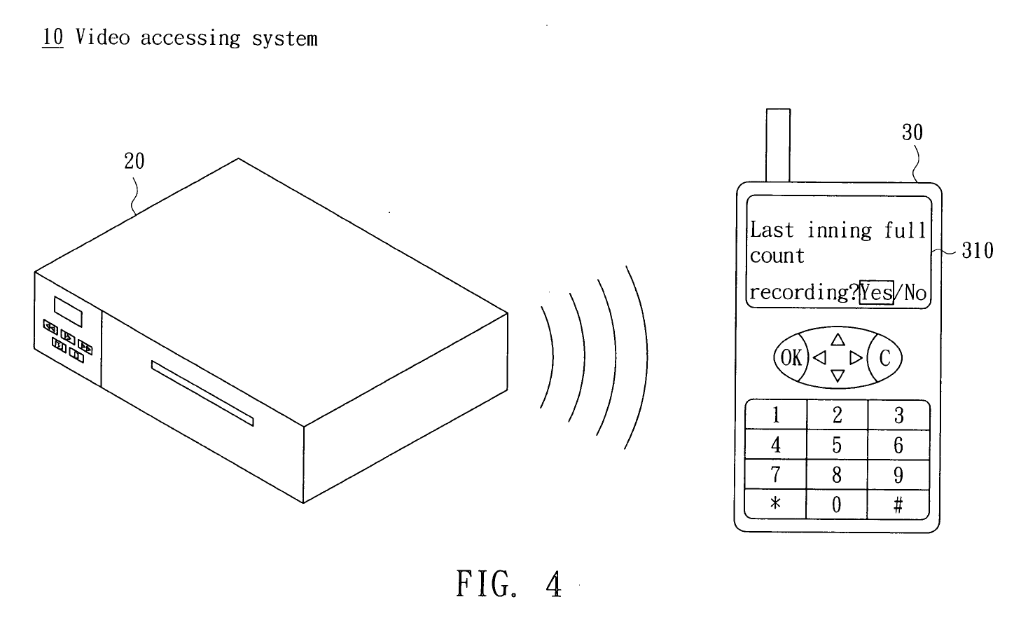

Referring to FIG. 4, a perspective of the second embodiment is shown. For example, the first message S1 displays a selection column on the playing unit 310 for the user to determine whether to record the real-time information R corresponding to the text message. If the user selects “Yes”, the mobile communication apparatus 30 sends a second message S2 to the video access apparatus 20.

According to the second message S2, the video access apparatus 20 drives the recording module 240 to select the real-time information R corresponding to the first message S1 from the buffer 210 and record the real-time information R to a storage media 250.

Moreover, the playing unit 310 of the mobile communication apparatus 30 can be a speaker. The mobile communication apparatus 30 further comprises a text/voice interface 330, which converts the above text message to an audio frequency signal. The audio frequency signal is outputted to be played on the speaker.

According to the voice played by the speaker, the user sends a second message S2 to the video access apparatus 20 by the mobile communication apparatus 30 for driving the recording module 240 to implement the action requested by the second message S2.

### THIRD EMBODIMENT

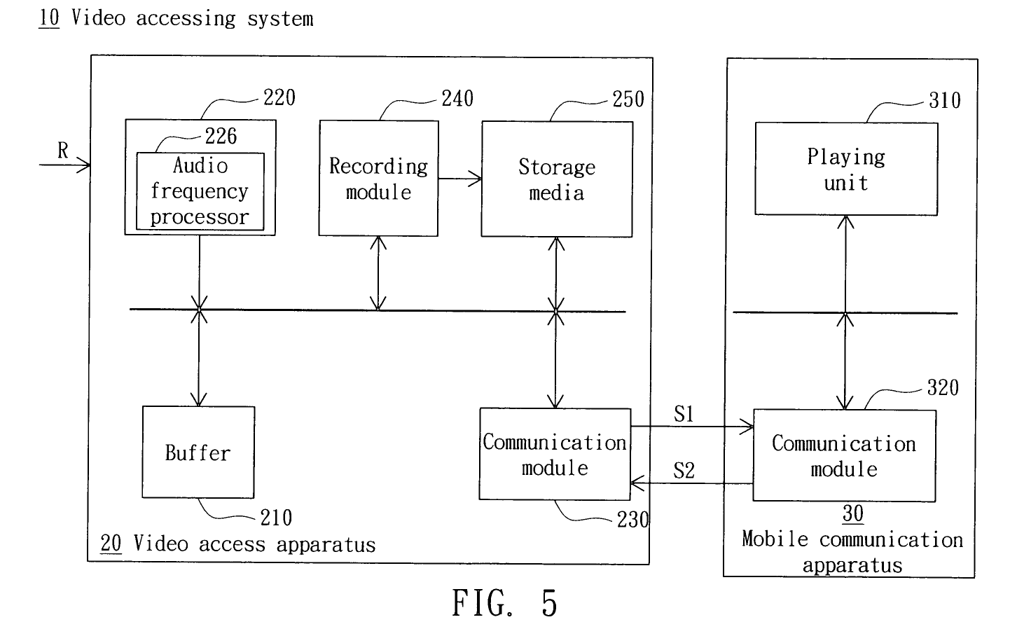

Referring to FIG. 5, a block diagram of a video accessing system according to a third embodiment of the invention is shown. The playing unit 310 of the mobile communication apparatus 30 can be a speaker. The information extracting unit 220 of the video access apparatus 20 further comprises an audio frequency processor 226. The audio frequency processor 226 generates a first message S1 according to the real-time information R. The first message S1 is an audio frequency signal.

After the first message S1 is received by the communication module 320 of the mobile communication apparatus 30, the first message S1 is outputted to be played on the playing unit 310. The user can listen to the voice played by the playing unit 310 and send a second message S2 to the video access apparatus 20 for driving the recording module 240 to implement the action requested by the second message S2.

The user can input a timer-recording setting to the video access apparatus 20 disclosed above in advance to receive the real-time information R. Examples of the setting of timer recording include the channel and the broadcasting schedule of TV programs.

After the user sets the timer recording with respect to the broadcasting channel and the broadcasting schedule of TV programs, the video access apparatus 20 sends a first message containing the setting of the broadcasting channel and the broadcasting schedule of TV programs to the mobile communication apparatus 30. Or, the user may preset the broadcasting channel of TV programs only, and the video access apparatus 20 will send a first message containing the TV programs of the selected channel to the mobile communication apparatus 30.

According to the mobile communication apparatus 30, the user obtains the knowledge of TV programs via the display or the speaker, and determines whether to record the program or not according to the instantaneously broadcasted information.

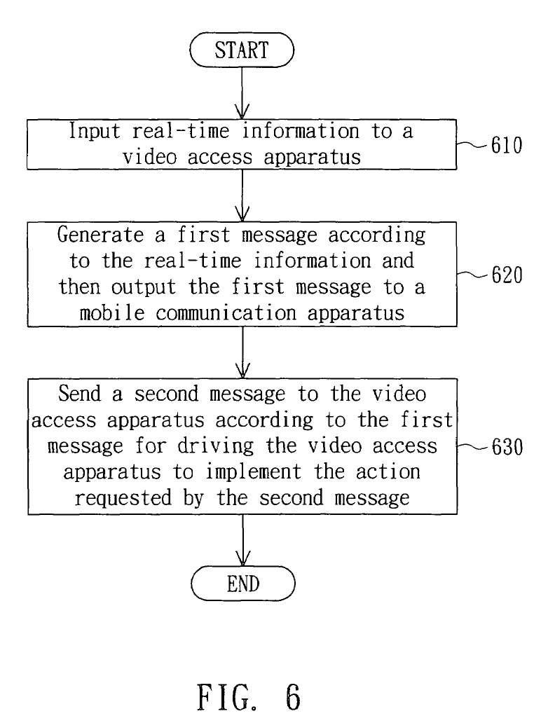

Referring to FIG. 6, a flowchart of a recording method according to a preferred embodiment of the invention is shown. The recording method is used in the video accessing system 10 disclosed above. The recording method comprises the following steps:

Firstly, as indicated in step 610, a piece of real-time information R is inputted to the video access apparatus 20.

Next, as indicated in step 620, a first message S1 is generated according to the real-time information R and outputted to the mobile communication apparatus 30 by the video access apparatus 20.

Then, as indicated in step 630, a second message S2 is sent to the video access apparatus 20 according to the first message S1 by the mobile communication apparatus 30 for driving the video access apparatus 20 to implement the action requested by the second message S2.

According to the video accessing system and recording method disclosed in the above embodiments of the invention, the contents of the real-time information are sent to the mobile communication apparatus in a first message. Then, the mobile communication apparatus broadcasts the contents of the real-time information accordingly. The user selects his or her favorite real-time information via the mobile communication apparatus and records the real-time information to the storage media. Thus, the user is able to obtain the most updated information, and further record his or her favorite TV programs via the mobile communication apparatus.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A recording method, comprising:
inputting real-time information to a video access apparatus;
generating a first message according to the real-time information and then outputting the first message to a mobile communication apparatus; and
sending a second message to the video access apparatus according to the first message for driving the video access apparatus to implement the action requested by the second message.

2. The recording method according to claim 1, wherein the video access apparatus comprises:
a buffer used for registering the real-time information;
an information extracting unit used for generating the first message according to the real-time information;
a communication module used for outputting the first message; and
a recording module used for recording the real-time information of the buffer to a storage media.

3. The recording method according to claim 2, wherein the mobile communication apparatus comprises:
a playing unit; and
a communication module used for receiving and outputting the first message to the playing unit, and sending the second message to the video access apparatus according to the first message for driving the recording module to implement the action requested by the second message.

4. The recording method according to claim 3, wherein the information extracting unit further comprises an audio frequency processor used for generating a first message according to the real-time information, the first message is an audio frequency signal, the playing unit is a speaker, and the audio frequency signal is outputted to be played on the speaker.

5. The recording method according to claim 3, wherein the information extracting unit comprises a voice recognizer used for generating a first message according to the real-time information.

6. The recording method according to claim 5, wherein the first message is a text message.

7. The recording method according to claim 6, wherein the text message is displayed on the playing unit.

8. The recording method according to claim 6, wherein the playing unit is a speaker, the mobile communication apparatus further comprises a text/voice interface for converting the text message to an audio frequency signal, and the audio frequency signal is outputted to be played on the speaker.

9. The recording method according to claim 3, wherein the information extracting unit comprises an image processor used for generating a first message according to the real-time information, the first message is an image signal.

10. The recording method according to claim 9, wherein the playing unit is a display, and the image signal is outputted to be displayed on the display.

11. A video accessing system, comprising:
a video access apparatus used for receiving real-time information, wherein the video access apparatus comprises:
a buffer used for registering the real-time information;
an information extracting unit used for generating a first message according to the real-time information;
a communication module used for outputting the first message; and
a recording module used for recording the real-time information of the buffer to a storage media; and
a mobile communication apparatus, comprising:
a playing unit; and
a communication module used for receiving and outputting the first message to the playing unit, and sending a second message to the video access apparatus according to the first message for driving the recording module to implement the action requested by the second message.

12. The video accessing system according to claim 11, wherein the information extracting unit further comprises an audio frequency processor used for generating a first message according to the real-time information, the first message is an audio frequency signal.

13. The video accessing system according to claim 12, wherein the playing unit is a speaker, and the first message is outputted to be played on the speaker.

14. The video accessing system according to claim 11, wherein the first message is a text message.

15. The video accessing system according to claim 14, wherein the information extracting unit comprises a voice recognizer used for generating a text message according to the real-time information.

16. The video accessing system according to claim 14, wherein the playing unit is a display, and the text message is displayed on the display.

17. The video accessing system according to claim 14, wherein the playing unit is a speaker, the mobile communication apparatus further comprises a text/voice interface used for converting the text message to an audio frequency signal, the audio frequency signal is outputted to be played on the speaker.

18. The video accessing system according to claim 11, wherein the information extracting unit comprises an image processor used for generating a first message according to the real-time information, the first message is an image signal.

19. The video accessing system according to claim 18, wherein the playing unit is a display, and the image signal is outputted to be displayed on the display.
